(19) United States
(12) Patent Application Publication
(10) Pub. No.: US 2025/0291748 A1
(43) Pub. Date: Sep. 18, 2025

(54) INTERCONNECT PROVIDING FREEDOM FROM INTERFERENCE

(71) Applicant: Mercedes-Benz Group AG, Stuttgart (DE)

(72) Inventor: Francois PIEDNOEL, Sunnyvale, CA (US)

(21) Appl. No.: 18/604,265

(22) Filed: Mar. 13, 2024

(51) Int. Cl. G06F 13/20

(52) U.S. Cl. CPC G06F 13/20; G06F 2213/40

(57) ABSTRACT

An interconnect for providing freedom from interferences can include a set of mainband data paths and a set of sideband data paths. The set of mainband data paths receive constant voltage from a first voltage regulator powered by a first power source, and the set of sideband data paths receive constant voltage from a second voltage regulator powered by a second power source.

### BACKGROUND

Universal Chiplet Interconnect Express (UCIe) provides an open specification for an interconnect and serial bus between chiplets, which enables the production of system-on-chip (SoC) packages with intermixed components from different silicon manufacturers. It is contemplated that autonomous vehicle computing systems may operate using chiplet arrangements that follow the UCIe specification.

### SUMMARY

An interconnect for a computing device is described herein that can include a set of mainband data paths and a set of sideband data paths. In various examples, the set of mainband data paths may receive constant voltage from a first voltage regulator powered by a first power source, and the set of sideband data paths may receive constant voltage from a second voltage regulator powered by a second power source. For example, a first phase-locked loop associated with the set of mainband data paths may receive constant voltage from the first voltage regulator and a second phase-locked loop associated with the set of sideband data paths may receive constant voltage from the second voltage regulator.

In certain implementations, a shared ground coupled to each set of data paths electrically isolates the mainband data paths from the sideband data paths to provide freedom from interference between the mainband and sideband data paths. Furthermore, an interface between the set of mainband data paths and the set of sideband data paths can include one or more de-capping components to prevent current and/or voltage fluctuations between the set of mainband data paths and sideband data paths and eliminate transient noise between the two.

According to various embodiments, the set of mainband data paths of the interconnect may transmit production network data or performance data between chiplets of the computing device. For example, the chiplets of the computing device may be included on a system-on-chip or multiple-system-on-chip for obtaining and processing data this production network data or performance data. In certain examples, the set of sideband data paths can transmit functional safety data between the chiplets of the computing device, which can include health monitoring information corresponding to hardware components of the computing device.

In certain embodiments, the chiplets can be arranged on the system-on-chip or multiple-system-on chip in any manner, and can include any combination of data input chiplet(s) (e.g., a sensor data input chiplet), central chiplet (e.g., include a shared memory and/or reservation table), general compute chiplets, high-bandwidth memory (HBM) chiplets, machine learning accelerator chiplet(s), and the like. Each of the chiplets may be connected by one or more multiple interconnects described in accordance with embodiments herein.

A system-on-chip is also described herein that includes a sensor data input chiplet to receive sensor data from a sensor system comprising a set of cameras, and a set of LIDAR and radar sensors. The system-on-chip further includes a central chiplet comprising a shared memory. In various examples described herein, the sensor data input chiplet and the central chiplet can be coupled by a first interconnect that transmits image data from the set of cameras and a second interconnect that transmits LIDAR and radar data from the set of LIDAR and radar sensors. It is contemplated that additional interconnects can couple the sensor data input chiplet and the central chiplet, such as three interconnects (e.g., a first interconnect for transmitting image data, a second interconnect for transmitting LIDAR data, and a third interconnect for transmitting proximity sensor data, such as radar data IR data, ultrasonic sensor data, and the like). In certain implementations, the central chiplet can include a functional safety (FuSa) program that performs health monitoring on the system-on-chip using a FuSa data path included in the set of sideband data paths of each of the first interconnect and the second interconnect.

In various examples, the set of mainband data paths of the first interconnect may transmit the image data from the set of cameras, and the set of mainband data paths of the second interconnect may transmit the LIDAR and radar data from the set of LIDAR and radar sensors. In further examples, the set of sideband data paths of the first interconnect and the second interconnect may transmit functional safety data between the sensor data input chiplet and the central chiplet. The first and second interconnects may further be connected by a bridge data path that enables transmission of image data to the central chiplet when the first interconnect fails, and transmission of LIDAR and radar data to the central chiplet when the second interconnect fails.

As provided herein, the system-on-chip may be included in a computing environment that includes multiple power sources (e.g., a vehicle that includes an alternator, 12-volt battery, battery pack, auxiliary batteries, and the like). In further examples, the system-on-chip may be included in computing environments such as datacenters, cloud computing platforms, application-based computing systems, robotics computing systems, artificial intelligence platforms, autonomous vehicle platforms, and the like. Such computing environments can also involve systems-on-chip, multiple-systems-on-chip, or monolithic chips disposed in any type of computing device, such as servers, personal computers, mobile computing devices, and the like. Each computing environment may include multiple independent power sources for operating independent components of the systems-on-chip.

For example, the mainband data paths of the interconnects can be independently powered by a first power source and the sideband data paths of the interconnects can be powered by a second power source. In further examples, the computing environment housing the systems-on-chip can comprising independent power sources for the set of cameras and the LIDAR and radar sensors. As such, the computing environment can be configured with freedom from interference and redundancy to provide increased safety and reliability of the computing environment. In autonomous vehicle implementations, such independence and redundancy can serve to increase the automotive safety integrity level (ASIL) rating of individual components of an autonomous drive computing system as well as the entire autonomous drive system of the vehicle.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1A is a block diagram depicting an embodiment of an interconnect providing freedom from interference, in accordance with examples described herein;

FIG. 1B is a block diagram depicting an embodiment of an interconnect providing freedom from interference, according to examples described herein;

FIG. 1C is a block diagram depicting an embodiment of an interconnect providing freedom from interference, according to examples described herein;

FIG. 1D block diagram depicting an embodiment of an interconnect providing freedom from interference, according to examples described herein;

FIG. 2 is a block diagram depicting a system-on-chip (SoC) in which examples described herein may be implemented, in accordance with examples described herein;

FIG. 3 is a block diagram illustrating an example central chiplet of an SoC arrangement for executing workloads, in accordance with examples described herein; and

FIG. 4 is a flow chart describing an example method of processing sensor data using multiple interconnects, in accordance with examples described herein.

### DETAILED DESCRIPTION

ISO 26262 defines freedom from interference as the absence of cascading failures between two or more elements that could lead to the violation of a safety requirement. An element is a system or part of a system including components, hardware, software, hardware parts, and software units, and a cascading failure is any failure of an element causing another element of the same item to fail. ISO 26262 specifies three types of interference: timing and execution, memory, and exchange of information. Interferences in the memory space domain occur when a software element accesses or modifies code or data belonging to another software element. Interferences due to exchange of information are sender and receiver related and are caused by errors such as repetition of information, loss of information, delay of information, insertion of information, blocking a communication channel, etc.

For UCIe die-to-die interconnects between chiplets of SoC packages, a high-performance mainband for the transmission of data may be complemented with a high-reliability sideband for transmitting functional safety, clocking, and/or other health monitoring information. A UCIe standardized physical layer, protocol stack, software model, and compliance testing enable users to readily mix and match chiplet components from multiple manufacturers, and further facilitate customized SoC packaging.

A primary goal of advancing autonomous vehicle technology is increasing the automotive safety integrity level (ASIL) of various electric and electronic (E/E) components of vehicles that are relevant to autonomous vehicle functions. One method of increasing the ASIL of autonomous drive features and functions is to provide freedom from interference between components to minimize random hardware errors and systematic hardware and software errors.

In certain implementations, example computing systems described herein can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic. In some examples, a computing “apparatus” can comprise a computing system, such as a system of one or more servers, or an on-board, autonomous vehicle computing system. In variations, a computing apparatus can comprise a computing device, such as computing resources included on a circuit board, personal computer, smartphone computer, tablet computer, laptop, and the like.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

In some embodiments, a computing system implementing the processes described herein can include one or more control circuits that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the control circuit(s) and/or computing system may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” may be used herein interchangeably with “and/or”).

In an embodiment, the control circuit(s) may be programmed by one or more computer-readable or computer-executable instructions stored on the non-transitory computer-readable medium. The non-transitory computer-readable medium may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium may form, for example, a computer diskette, a hard disk drive (HDD), a solid-state drive (SDD) or solid state integrated memory, a random access memory (RAM), a read-only memory (ROM), an erasable programmable read-only memory (EPROM or Flash memory), a static random access memory (SRAM), and/or dynamic random access memory (DRAM). In some cases, the non-transitory computer-readable medium may store computer-executable instructions or computer-readable instructions, such as instructions to perform the methods described throughout the present disclosure.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit to perform one or more functional tasks. The modules and computer-readable/executable instructions may be described as performing various operations or tasks when the control circuit(s) or other hardware components execute the modules or computer-readable instructions.

In further embodiments, the computing system can include a communication interface that enables communications over one or more networks to transmit and receive data. In various examples, the computing system can communicate, over the one or more networks, with fleet vehicles using the communication interface to receive sensor data and implement the intersection classification methods described throughout the present disclosure. In certain embodiments, the communication interface may be used to communicate with one or more other systems. The communication interface may include any circuits, components, software, etc. for communicating via one or more networks (e.g., a local area network, wide area network, the Internet, secure network, cellular network, mesh network, and/or peer-to-peer communication link). In some implementations, the communication interface may include for example, one or more of a communications controller, receiver, transceiver, transmitter, port, conductors, software and/or hardware for communicating data/information.

As an example embodiment, the control circuit(s) of the computing system can include a SoC arrangement that facilitates the various methods and techniques described throughout the present disclosure. In various examples, the SoC can include a set of chiplets, including a central chiplet comprising a shared memory in which a reservation table is utilized to execute various autonomous driving workloads, as described herein.

### Example Interconnects

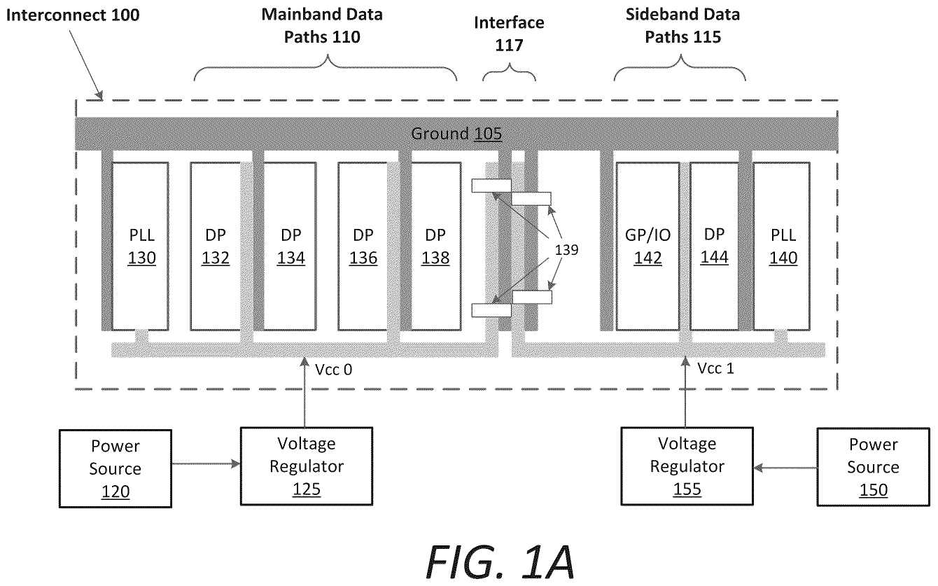

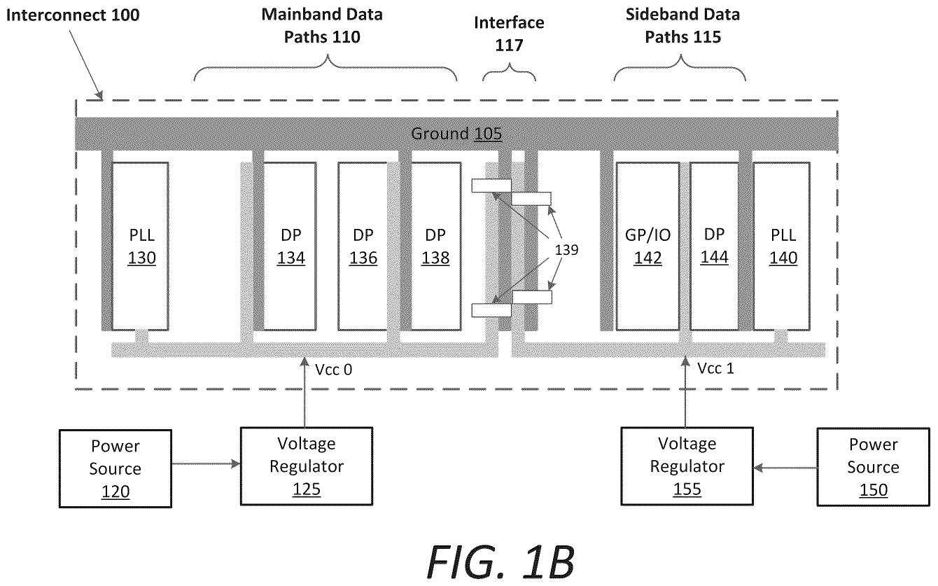

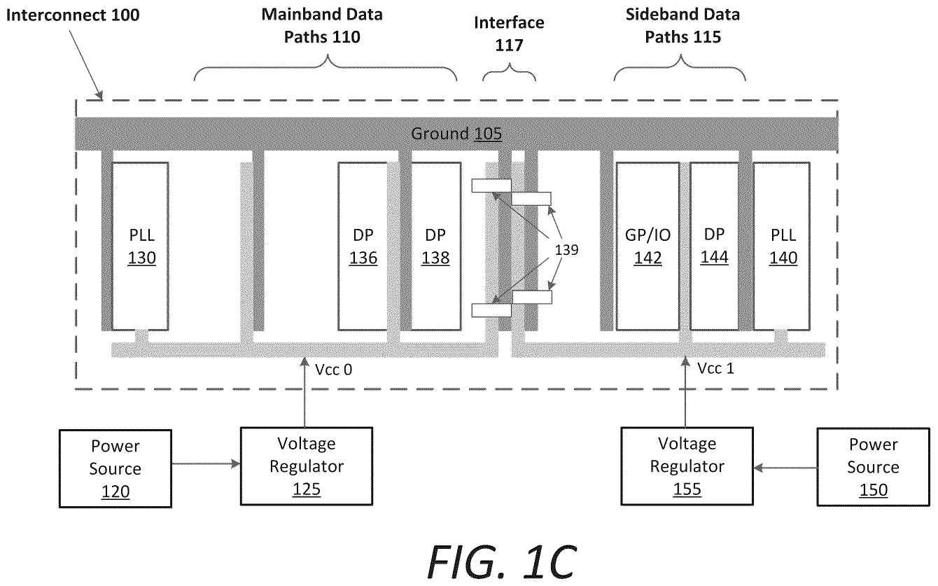

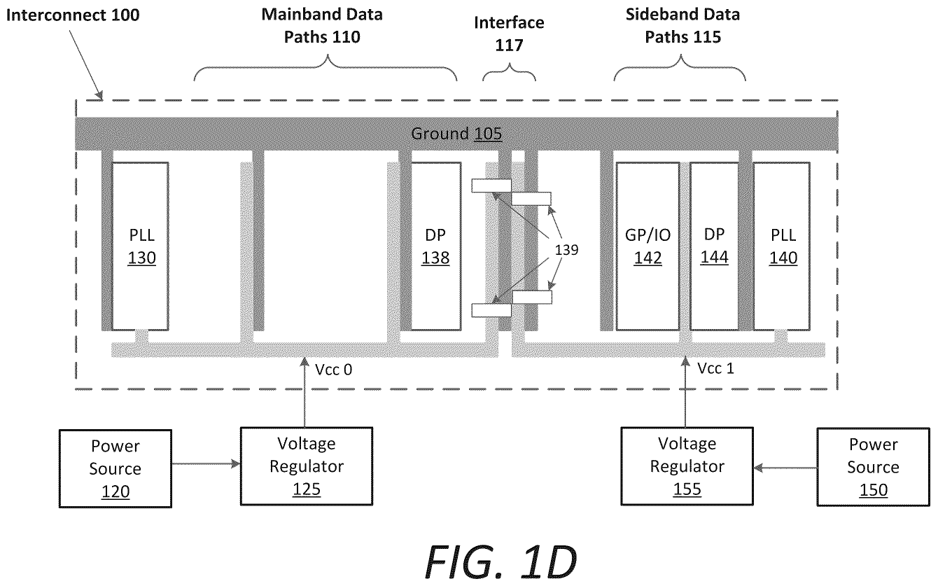

FIGS. 1A through 1D are block diagrams depicting example interconnects providing freedom from interference, in accordance with examples described herein. Referring to FIG. 1A, the interconnect 100 providing freedom from interference can include a set of mainband data paths 110 comprising data paths 132, 134, 136, and 138, and a set of sideband data paths 115 comprising a general purpose input/output data path 142 and data path 144. As provided herein, the interconnect 100 may comprise any combination and ratio of data paths in the mainband versus the sideband. As further provided herein, it is contemplated that any component shown in FIGS. 1A, 1B, 1C, and 1D may be included or omitted in an embodiment. For example, any of the embodiments in FIGS. 1A, 1B, 1C, and 1D may include or omit the general purpose input/output data path 142. In an embodiment, the mainband data path(s) 110 may refer to the mainband data path (also referred to as mainband bus) in the UCIe specification, and the sideband data path(s) may refer to the sideband data path (also referred to as sideband bus) in the UCIe specification. As an example, certain embodiments may provide for the mainband having 16 Gbps capacity for transmitting and receiving data, whereas the sideband may have 800 Mbps capacity. It is contemplated that future embodiments may have increased capacity for data transmissions in both the mainband and sideband. Further description of example interconnects comprising mainband and sideband data paths or buses is provided in PCT Application No.______, filed on______, which corresponds to U.S. Provisional Application No. 63/543,791, filed on Oct. 12, 2023; and PCT Application No.______, filed on______, which corresponds to U.S. Provisional Application No. 63/544,574, filed on Oct. 17, 2023, each of which is incorporated by reference herein in their respective entireties.

Referring to the embodiment shown in FIG. 1B, the interconnect 100 includes three data paths 134, 136, and 138, whereas the sideband includes one data path 144. As another example, referring to FIG. 1C, the interconnect 100 includes a two-to-one ratio of data paths between the mainband (data paths 136 and 138) and the sideband (data path 144). As yet another example, referring to FIG. 1D, the mainband includes a single data path 138 whereas the sideband also includes a single data path 144. With reference to each of FIGS. 1A, 1B, 1C, and 1D, the phase-locked loop 130 of the mainband data paths 110 remains fixed despite the changes in configurations of the main data paths 110. This allows for compatibility between each of the interconnects 100 in FIGS. 1A, 1B, 1C, and 1D, such that any embodiment shown can connect with any other embodiment.

Furthermore, each of the interconnects 100 shown in FIGS. 1A, 1B, 1C, and 1D can include common components, and as such, the description of these components may be shared between the different embodiments. For example, the description of the shared ground 105 when referring to FIG. 1A may also describe the shared ground 105 as shown in FIGS. 1B, 1C, and 1D. Still further, description of the components external to the interconnect 100, such as the first power source 120, first voltage regulator 125, second power source 150, and second voltage regulator 155, may also be shared between the different embodiments as shown and described with respect to FIGS. 1A, 1B, 1C, and 1D.

As provided herein, the term “data path” may be used interchangeably with “lane,” “slice,” or any other suitable term for a component of the interconnect 100 through which data is communicated. In certain implementations, the set of mainband data paths 110 and/or the set of sideband data paths 115 may include a general-purpose input/output data path 142 that may be used for any purpose, such as functional safety health monitoring or clock rate configuration.

In various examples, the mainband data paths 110 are electrically isolated from the sideband data paths 115 based on a shared ground 105, a first power source 120 that provides power to a first voltage regulator 125, and a second power source 150 that provides power to a second voltage regulator 155. The first voltage regulator 125 provides constant voltage to a first phase-locked loop 130 associated with the mainband data paths 110, and the second voltage regulator 155 provides constant voltage to a second phase-locked loop associated with the sideband data paths 115. As provided herein, the first power source 120 can comprise a first battery or power supply that draws power from a source that is independent from power source 150. Accordingly, if power source 150 fails, power source 120 may still provide power to the mainband data paths 110. Likewise, the second power source 150 can comprise a second battery or second power supply that draws power from a source that is independent from power source 120. Accordingly, if power source 120 fails, power source 150 may still provide power to the sideband data paths 115.

Each voltage regulator 125, 155 receives electrical current from their respect power sources 120, 150, which can comprise direct current (e.g., from one or more batteries) or alternating current from an alternator, wall socket, etc. The voltage regulators 125, 155 can function to maintain a constant voltage (Vcc 0 and Vcc 1) for each of the mainband data paths 110 and the sideband data paths 115. The phase-locked loop 130 of the mainband data paths 110 and the phase-locked loop 140 of the sideband data paths 115 can each comprise a control system that generates output signals that have fixed phase relative to phases of the voltage signals from the voltage regulators 125, 155.

According to various examples, an interface 117 can electrically isolate the mainband data paths 110 from the sideband data paths 115 to provide freedom from interference between the two. As such, if a failure occurs in one or more components associated with the mainband data paths 110, the sideband data paths 115 may continue to operate. Likewise, if a failure occurs in one or more components associated with the sideband data paths 115, the mainband data paths 110 may continue to operate.

As shown in FIG. 1A, the shared ground 105 comprises a set of spires or cavitations that are disposed between the phase-locked loop 130 and certain data paths 132, 134, 136, 138 of the mainband data paths 110, and the phase-locked loop 140 and certain data paths 142, 144 of the sideband data paths 115. In accordance with examples provided herein, the arrangement of the shared ground 105 spires or cavitations are shown in FIG. 1A for illustrative purposes, and may be arranged in any suitable manner so as provide freedom from interference between the mainband data paths 110 and the sideband data paths 115. For example, the shared ground 105 can include spires or cavitations between phase-locked loop 130 and data path 132, between data path 134 and data path 136, and/or between data path 142 and 144.

In further implementations, the interface 117 between the mainband data paths 110 and the sideband data paths 115 can include multiple spires or cavitations for the shared ground 105, and can further comprise an interface 117 between one or more spires of the electrical conductor for the mainband data paths 110 (providing voltage Vcc 0) and one or more spires of the electrical conductor for the sideband data paths 115 (providing voltage Vcc 1). One or more de-capping components 139 (e.g., decoupling capacitors) can further be included in the interface 117 to eliminate any transient noise from Vcc 0 or Vcc 1.

In various examples, the mainband data paths 110 can transmit production data (e.g., sensor data) over a high-performance network of the system-on-chip (SoC). The sideband data paths 115 can transmit functional safety (FuSa) data over a high-reliability network to perform health monitoring tasks for the hardware components of the SoC. In further examples, the sideband data paths 115 can transmit clock signals between the chiplets of the SoC. For example, the sideband data paths 115 can include a first lane for transmitting clock signals and a second lane for transmitting FuSa information (e.g., hardware performance data, temperature information, data requests and acknowledgments, and the like).

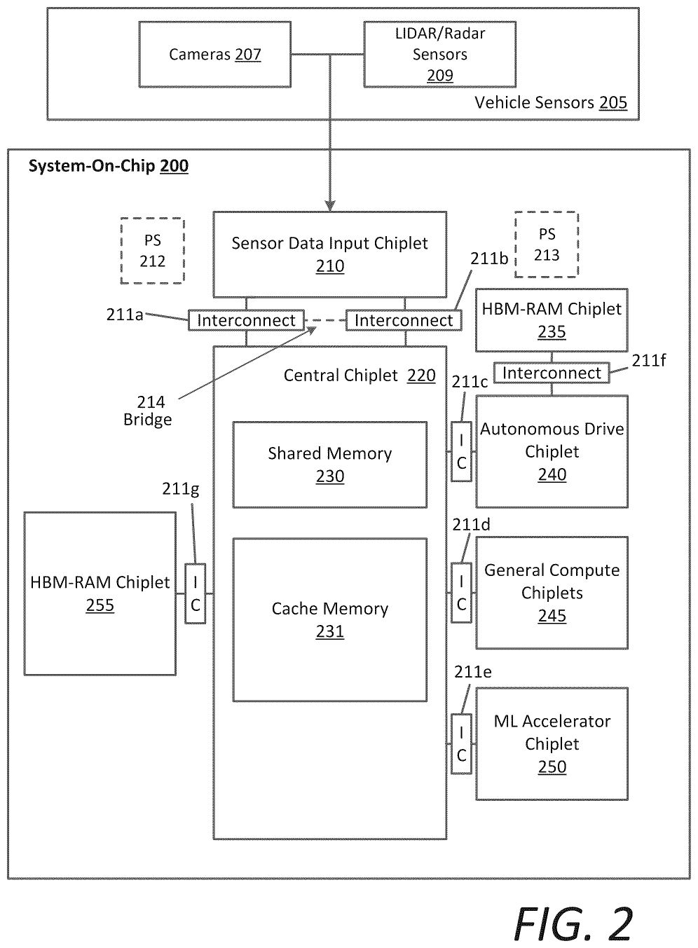

For autonomous vehicle implementations, the mainband data paths 110 can functions to transmit raw or processed sensor data between chiplets and caches of the SoC. In particular, the sensor data can be obtained from a sensor system of the vehicle, which can include any combination of cameras, LIDAR sensors, radar sensors, ultrasonic sensors, proximity sensors, and the like. The individual chiplets of the SoC can each process the sensor data from the various sensors to provide a sensor view of the surrounding environment of the vehicle (e.g., a dynamic, three-dimensional sensor-fused view), and certain chiplets can perform inference operations on the sensor view. Further description of the SoC is provided below with respect to FIG. 2.

### Example System-On-Chip

FIG. 2 is a block diagram illustrating an example system-on-chip (SoC) 200, in accordance with examples described herein. The example SoC 200 shown in FIG. 2 can include additional components, and the components of the SoC 200 may be arranged in various alternative configurations other than the example shown. Thus, the SoC 200 of FIG. 2 is described herein as an example arrangement for illustrative purposes and is not intended to limit the scope of the present disclosure in any manner. Furthermore, while the example SoC 200 shown in FIG. 2 is specified for autonomous vehicle implementations, the SoC 200 may alternatively be configured for general data processing using any type of data. Accordingly, in such alternative implementations, the vehicle sensors 205 shown in FIG. 2 may comprise any data source, and the sensor data input chiplet 210 shown in FIG. 2 may comprise any data input chiplet.

Referring to FIG. 2, a sensor data input chiplet 210 of the SoC 200 can receive sensor data from various vehicle sensors 205 of the vehicle. These vehicle sensors 205 can include any combination of cameras 207 (e.g., single cameras, binocular cameras, fisheye lens cameras, etc.), LIDAR and radar sensors 207, ultrasonic sensors, proximity sensors, and the like. The sensor data input chiplet 210 can automatically dump the received sensor data as it is received into a cache memory 231 of the central chiplet 220. The sensor data input chiplet 210 can also include an image signal processor (ISP) responsible for capturing, processing, and enhancing images taken from the various vehicle sensors 205. The ISP takes the raw image data and performs a series of complex image processing operations, such as color, contrast, and brightness correction, noise reduction, and image enhancement, to create a higher-quality image that is ready for further processing or analysis by the other chiplets of the SoC 200. The ISP may also include features such as auto-focus, image stabilization, and advanced scene recognition to further enhance the quality of the captured images. The ISP can then store the higher-quality images in the cache memory 231.

In some aspects, the sensor data input chiplet 210 publishes identifying information for each item of sensor data (e.g., images, point cloud maps, etc.) to a shared memory 230 of a central chiplet 220, which acts as a central mailbox for synchronizing workloads for the various chiplets. The identifying information can include details such as an address in the cache memory 231 where the data is stored, the type of sensor data, which sensor captured the data, and a timestamp of when the data was captured.

In accordance with examples described herein, the sensor data input chiplet 210 can communicate with the central chiplet 220 through a first interconnect 211a and a second interconnect 211b. The first interconnect 211a can be dedicated for the transmission of image data from the cameras 207 of the vehicle sensors 205. The second interconnect 211b can be dedicated for the transmission of radar data and LIDAR data from the radar and LIDAR sensors 209 of the vehicle sensors 205. As provided herein, the first interconnect 211a and the second interconnect 211b can each correspond to the interconnect 100 described with respect to FIGS. 1A-1D. Alternatively, the first and second interconnects 211a, 211b can comprise general interconnects that do not include the freedom from interference features of the interconnect 100 described with respect to FIGS. 1A-1D.

In various embodiments, the sensor data input chiplet 210 may generally parse the sensor data to separately transmit image data from the cameras 207 of the vehicle over the first interconnect 211a and LIDAR and radar data from the LIDAR and radar sensors 209 of the vehicle over the second interconnect 211b. In certain examples, the first interconnect 211a may generally be powered by a first power source 212 (e.g., a battery pack of the vehicle) and the second interconnect 211b may be powered by a second power source 213 (e.g., an auxiliary battery of the vehicle) that is electrically independent of the first power source 212. Furthermore, the camera sensors 207 may be powered by the first power source 212 and the LIDAR and radar sensors 209 may be powered by the second power source 213.

As provided herein, if a fault or failure occurs in the first interconnect 211a, the camera sensors 207, or first power source 212 (e.g., independently powering the camera sensors 207 and first interconnect 211a), then the LIDAR and radar sensors 209, second interconnect 211b, and the second power source 213 (e.g., independently powering the LIDAR and radar sensors 209 and second interconnect 211b) may remain unaffected. In real-world implementations, the vehicle may continue to operate using LIDAR and radar data (e.g., in a degraded or high-caution mode). Conversely, if a fault or failure occurs in the second interconnect 211b, the LIDAR and radar systems 209, or second power source 213, then the camera sensors 207, first interconnect 211a, and first power source 212 may remain unaffected, and the vehicle may continue to operate using image data from the cameras 207 (e.g., in a degraded or high-caution mode). As provided herein, the power sources 212, 213 may comprise components of the SoC 200, or can be included external to the SoC 200.

In certain embodiments, a data bridge 214 may be present between the first interconnect 211a and the second interconnect 211b that can facilitate limited communication of sensor data that would otherwise be transmitted over the failed interconnect, as shown in FIG. 2. Accordingly, for example, when the first interconnect 211a fails, a certain amount of image data at a certain reduced frequency can be transmitted over the data bridge 214. This image data can enable workload processing chiplets of the SoC 200 to compare LIDAR and radar data to the image data to, for example, confirm inferences (e.g., to verify identified objects in the LIDAR and/or radar data). Likewise, when the second interconnect 211b fails, a certain amount of radar and LIDAR data can be transmitted over the data bridge 214. This LIDAR and radar data can enable workload processing chiplets of the SoC 200 to compare LIDAR and radar data to the image data for inference confirmation.

As provided herein, the existence of two interconnects for transmitting sensor data separately creates modality, adds to functional safety of the autonomous drive system, and increases the ASIL rating of the autonomous drive system. In variations, the sensor data input chiplet 210 can communicate with the central chiplet 220 over more than two interconnects, where each interconnect may be dedicated for transmitting a specified data type (e.g., LIDAR data only, radar data only, image data only, etc.), or may be dedicated for transmitting certain portions of multiple data types (e.g., images and LIDAR data from specified cameras and LIDAR sensors).

In various examples, each the first interconnect 211a and the second interconnect 211b can include mainband data paths comprising a high-performance network in the die-to-die interfaces between chiplets, and sideband data paths comprising a high-reliability network in the die-to-die interfaces between the chiplets. For example, the mainband data paths can be used by the SoC 200 to transmit raw and processed sensor data between the sensor data input chiplet, caches, and processing cores of workload processing chiplets, whereas the sideband data paths 115 can be used by the SoC to transmit function safety (FuSa) communications comprising error correction code (ECC), data transmission confirmations, and the like. For example, each of the first interconnect 211a and the second interconnect 211b can comprise freedom from interference features as described with respect to the interconnect 100 shown in FIGS. 1A-1D.

According to embodiments, interconnects 211a-g can each represent chip-to-chip (C2C) or die-to-die (D2D) interfaces between the chiplets of the SoC 200. As provided herein, the interconnects 211a-g can include high-bandwidth data paths used for general data purposes to the cache memory 231 and high-reliability data paths to transmit FuSa and scheduler information to the shared memory 230. Depending on bandwidth requirements, an interconnect 211a-g may include more than one die-to-die interface. For example, the first interconnect 211a and second interconnect 211b can include two interfaces to support higher bandwidth communications between the sensor data input chiplet 210 and the central chiplet 220.

In one aspect, the interconnects 211a-g implement the Universal Chiplet Interconnect Express (UCIe) standard and communicate through an indirect mode to allow each of the chiplet host processors to access remote memory as if it were local memory. This is achieved by using a specialized Network-on-Chip (NoC) Network Interface Unit (NIU) (e.g., which allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the SoC 200 can include additional chiplets that can store, alter, or otherwise process the sensor data cached by the sensor data input chiplet 210. The SoC 200 can include an autonomous drive chiplet 240 that can perform the perception, sensor fusion, trajectory prediction, and/or other autonomous driving algorithms of the autonomous vehicle. The autonomous drive chiplet 240 can be connected to a dedicated HBM-RAM chiplet 235 in which the autonomous drive chiplet 240 can publish all status information, variables, statistical information, and/or processed sensor data as processed by the autonomous drive chiplet 240.

In various examples, the system on chip 200 can further include a machine-learning (ML) accelerator chiplet 240 that is specialized for accelerating machine-learned or AI workloads, such as image inferences or other sensor inferences using machine learning, in order to achieve high performance and low power consumption for these workloads. The ML accelerator chiplet 240 can include an engine designed to efficiently process graph-based data structures, which are commonly used in AI workloads, and a highly parallel processor, allowing for efficient processing of large volumes of data. The ML accelerator chiplet 240 can also include specialized hardware accelerators for common AI operations such as matrix multiplication and convolution as well as a memory hierarchy designed to optimize memory access for AI workloads, which often have complex memory access patterns.

The general compute chiplets 245 can provide general purpose computing for the system on chip 200. For example, the general compute chiplets 245 can comprise high-powered central processing units and/or graphical processing units that can support the computing tasks of the central chiplet 220, autonomous drive chiplet 240, and/or the ML accelerator chiplet 250.

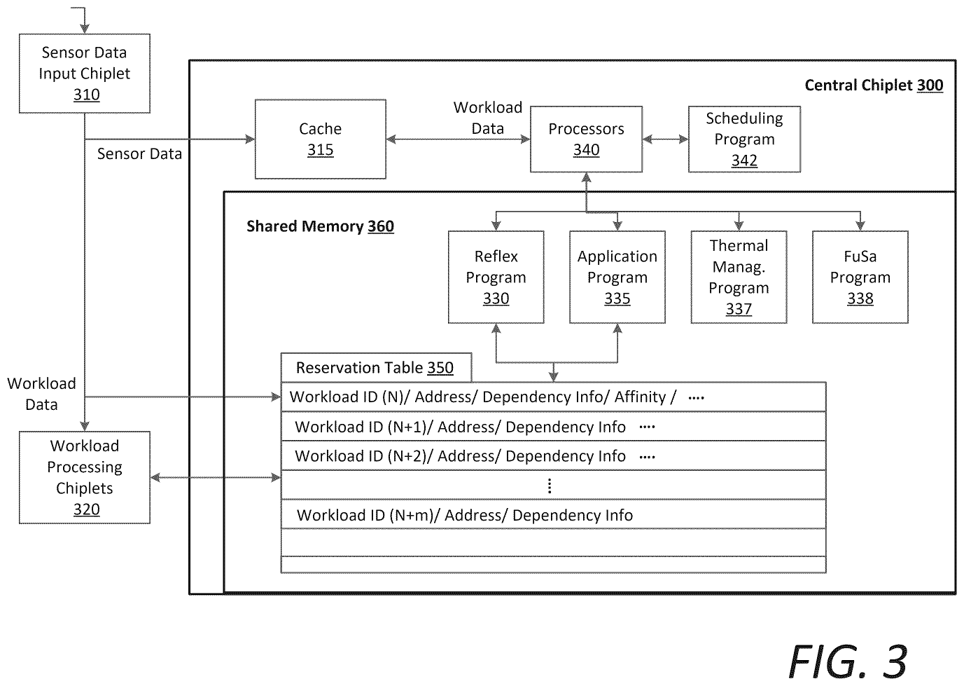

In various implementations, the shared memory 230 can store programs and instructions for performing autonomous driving tasks. The shared memory 230 of the central chiplet 220 can further include a reservation table that provides the various chiplets with the information needed (e.g., sensor data items and their locations in memory) for performing their individual tasks. In various aspects, the central chiplet 220 also includes the large cache memory 231, which supports invalidate and flush operations for stored data. Further description of the shared memory 230 in the context of the central chiplet 220 is provided below with respect to FIG. 3.

Cache miss and evictions from the cache memory 231 are sent by a high-bandwidth memory (HBM) RAM chiplet 255 connected to the central chiplet 220. The HBM-RAM chiplet 255 can include status information, variables, statistical information, and/or sensor data for all other chiplets. In certain examples, the information stored in the HBM-RAM chiplet 255 can be stored for a predetermined period of time (e.g., ten seconds) before deleting or otherwise flushing the data. For example, when a fault occurs on the autonomous vehicle, the information stored in the HBM-RAM chiplet 255 can include all information necessary to diagnose and resolve the fault. Cache memory 231 keeps fresh data available with low latency and less power required compared to accessing data from the HBM-RAM chiplet 255.

As provided herein, the shared memory 230 can house a mailbox architecture in which a reflex program comprising a suite of instructions is used to execute workloads by the central chiplet 220, general compute chiplets 245, and/or autonomous drive chiplet 240. In certain examples, the central chiplet 220 can further execute a FuSa program that operates to compare and verify outputs of respective pipelines to ensure consistency in the ML inference operations. In still further examples, the central chiplet 220 can execute a thermal management program to ensure that the various components of the SoC 200 operate within normal temperature ranges.

### Example Central Chiplet

FIG. 3 is a block diagram illustrating an example central chiplet of an SoC arrangement for executing workloads, in accordance with examples described herein. The central chiplet 300 shown in FIG. 3 can correspond to the central chiplet 220 of the SoC 200 as shown in FIG. 2. Furthermore, the sensor data input chiplet 310 of FIG. 3 can correspond to the sensor data input chiplet 210 shown in FIG. 2, and the workload processing chiplets 320 shown in FIG. 3, can correspond to the general compute chiplets 245, ML accelerator chiplet 250, and/or the autonomous drive chiplet 240 shown in FIG. 2.

Referring to FIG. 3, the central chiplet 300 can include a shared memory 360 storing a reflex program 330 and an application program 335. As provided herein, the reflex program 330 can comprise a set of instructions for executing reflex workloads. The reflex workloads can comprise sensor data acquisition, sensor fusion, and inference tasks that facilitate scene understanding of the surrounding environment of the vehicle. These tasks can comprise two-dimensional image processing, sensor fused data processing (e.g., three-dimensional LIDAR, radar, and image fusion data), neural radiance field (NeRF) scene reconstruction, occupancy grid determination, object detection and classification, motion prediction, and other scene understanding tasks for autonomous vehicle operation.

As further provided herein, the application program 335 can comprise a set of instructions for operating the vehicle controls of the autonomous vehicle based on the output of the reflex workloads. For example, the application program 335 can be executed by one or more processors 340 of the central chiplet 300 and/or one or more of the workload processing chiplets 320 (e.g., the autonomous drive chiplet 240 of FIG. 2) to dynamically generate a motion plan for the vehicle based on the execution of the reflex workloads, and operate the vehicle's controls (e.g., acceleration, braking, steering, and signaling systems) to execute the motion plan accordingly.

In various implementations, the central chiplet 300 can include a set of one or more processors 340 (e.g., a transient-resistant CPU and general compute CPUs) that can execute a scheduling program 342 for execution of workloads as runnables in independent pipelines (e.g., in accordance with the compute task and data positioning optimizations described herein). In certain examples, one or more of the processors 340 can execute reflex workloads in accordance with the reflex program 330 and/or application workloads in accordance with the application program 335. As such, the processors 340 of the central chiplet 300 can reference, monitor, and update dependency information in workload entries of the reservation table 350 as workloads become available and are executed accordingly. For example, when a workload is executed by a particular chiplet, the chiplet updates the dependency information of other workloads in the reservation table 350 to indicate that the workload has been completed. This can include changing a binary value representing the workload (e.g., from 0 to 1) to indicate in the reservation table 350 that the workload has been completed. Accordingly, the dependency information for all workloads having dependency on the completed workload is updated accordingly.

According to examples described herein, the reservation table 350 can include workload entries, each of which indicates a workload identifier that describes the workload to be performed, an address in the cache memory 315 and/or HBM-RAM of the location of raw or processed sensor data required for executing the workload, any dependency information corresponding to dependencies that need to be resolved prior to executing the workload, and/or affinity information specifying which hardware component is to execute the runnable when the workload is available (e.g., when all dependencies are met). In certain aspects, the dependencies can correspond to other workloads that need to be executed. Once the dependencies for a particular workload are resolved, the workload entry can be updated (e.g., by the chiplet executing the dependent workloads, or by the processors 340 of the central chiplet 300 through execution of the scheduling program 342). When no dependencies exist for a particular workload as referenced in the reservation table 350, the workload can be executed in a respective pipeline by a corresponding workload processing chiplet 320.

In various implementations, the sensor data input chiplet 310 obtains sensor data from the sensor system of the vehicle, and stores the sensor data (e.g., image data, LIDAR data, radar data, ultrasonic data, etc.) in a cache 315 of the central chiplet 300. The sensor data input chiplet 310 can generate workload entries for the reservation table 350 comprising identifiers for the sensor data (e.g., an identifier for each obtained image from various cameras of the vehicle's sensor system) and provide an address of the sensor data in the cache memory 315. An initial set of workloads be executed on the raw sensor data by the processors 340 of the central chiplet 300 and/or workload processing chiplets 320, which can update the reservation table 350 to indicate that the initial set of workloads have been completed.

As described herein, the workload processing chiplets 320 monitor the reservation table 350 to determine whether particular workloads in their respective pipelines are ready for execution. As an example, the workload processing chiplets 320 can continuously monitor the reservation table using a workload window (e.g., an instruction window for multimedia data) in which a pointer can sequentially read through each workload entry to determine whether the workloads have any unresolved dependencies. If one or more dependencies still exist in the workload entry, the pointer progresses to the next entry without the workload being executed. However, if the workload indicates that all dependencies have been resolved (e.g., all workloads upon which the particular workload depends have been executed), then the relevant workload processing chiplet 320 and/or processors 340 of the central chiplet 300 can execute the workload accordingly.

In various examples, the shared memory 360 can include a thermal management program 337 executable by the one or more processors 340 to manage the various temperatures of the SoC 200, operate cooling components, perform hardware throttling, switch to backup components (e.g., a backup SoC), and the like. In still further examples, the shared memory 360 can include a FuSa program 338 that performs functional safety tasks for the SoC 200, such as monitoring communications within the SoC (e.g., using error correction code), comparing output of different pipelines, and monitoring hardware performance of the SoC.

In certain implementations, the thermal management program 337 and FuSa program 338 can perform their respective tasks using data transmitted over the high-reliability network, which utilizes the sideband data paths 115 of the example interconnect 100 shown in FIGS. 1A-1D. As described herein, the sideband data paths 115 are used for transmitting health monitoring data such as operating temperature information of hardware components of the individual chiplets, error correction code (ECC), data acknowledgements, and the like.

### Methodology

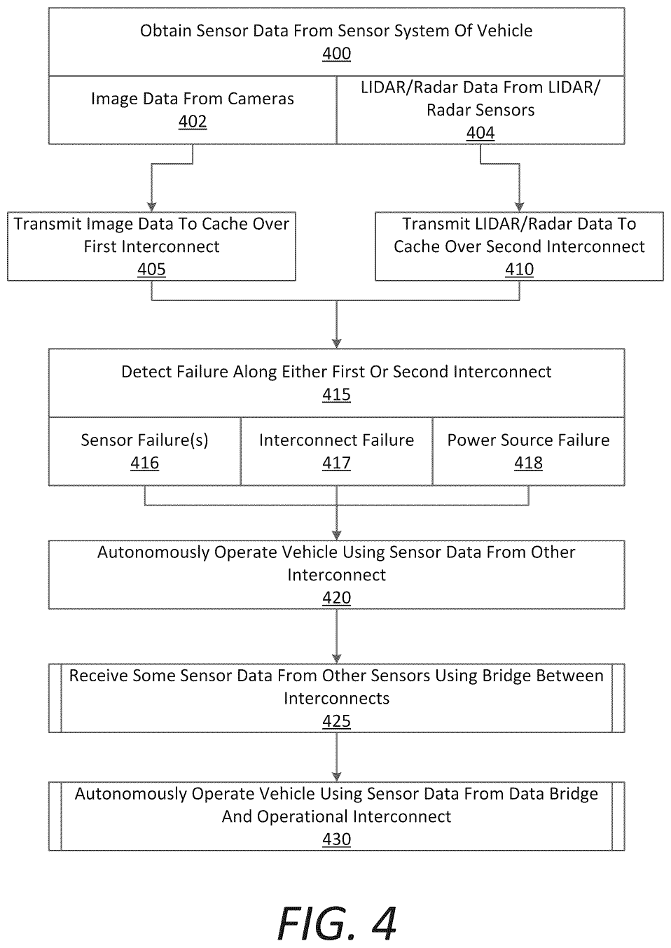

FIG. 4 is a flow chart describing an example method of processing sensor data using multiple interconnects, in accordance with examples described herein. In the below discussion of FIG. 4, reference may be made to reference characters representing various features as shown and described with respect to FIGS. 1A through 3. Furthermore, the processes described with respect to FIG. 4 may be performed by the various components of a system-on-chip 200 implementing a pair of interconnects 211a, 211b as shown and described with respect to FIG. 2. Still further, the processes of FIG. 4 need not be performed in the order(s) shown, but rather any step may be performed prior to, in conjunction with, or subsequent to any other step.

Referring to FIG. 4, at block 400, the sensor data input chiplet 210 can obtain sensor data from a sensor system of a vehicle. At block 402, the sensor data input chiplet 210 can obtain image data from the cameras 207 of the vehicle's sensor system, and at block 404, the sensor data input chiplet 210 can obtain LIDAR and radar data from the LIDAR and radar sensors 209 of the vehicle's sensor system. According to examples described herein, at block 405, the sensor data input chiplet 210 can transmit the image data from the cameras 207 to a particular cache (e.g., the cache memory 231 of the central chiplet 220) using a first interconnect 211a. At block 410, the sensor data input chiplet 210 can further transmit the LIDAR and radar data from the LIDAR and radar sensors 409 to a particular cache (e.g., the cache memory 231 of the central chiplet 220) using a second interconnect 211b.

It is contemplated herein, that the use of independent power sources 212, 213 for (i) the first interconnect 211a, cameras 207, and everything in between, and (ii) the second interconnect 211b, LIDAR and radar sensors 209, and everything in between provide modularity between the two systems such that a failure in one does not cascade into a failure of the other, thereby providing additional freedom from interference between the two systems. Furthermore, it is contemplated that when a failure of either system occurs, the SoC 200 may still perform autonomous drive functions (e.g., in a degraded state) using the sensor data from the still-operating system.

At any given time, at block 415, the central chiplet 220 may detect a failure corresponding to either the first interconnect 211a or the second interconnect 211b. These failures can correspond to sensor failures (block 416), interconnect failures (block 417), or a power source failure (block 418). At block 420, the SoC 200 can continue to autonomously operate the vehicle using sensor data from the interconnect that has not failed. For example, if a failure has occurred in the second interconnect 211b or LIDAR and radar system, the central chiplet 210 can still configure workload entries in the reservation table 350 based on image data received from the first interconnect 211a. In such examples, the SoC 200 can operate the vehicle in a degraded or high caution state (e.g., to pull the vehicle over or drive the vehicle to a safe location).

In certain implementations, a data bridge 214 can be included between the first interconnect 211a and the second interconnect 211b. At block 425, the central chiplet 220 may still receive some sensor data from the failed system using the data bridge 214 (e.g., when the sensors and power source still operate, but the interconnect fails). In such examples, at block 430, the SoC 200 may still autonomously operate the vehicle using sensor data from the data bridge 214 and the operational interconnect.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. An interconnect for a computing device, the interconnect comprising:
a set of mainband data paths; and
a set of sideband data paths;
wherein the set of mainband data paths receive constant voltage from a first voltage regulator powered by a first power source; and
wherein the set of sideband data paths receive constant voltage from a second voltage regulator powered by a second power source.

2. The interconnect of claim 1, further comprising:
a first phase-locked loop associated with the set of mainband data paths and receiving constant voltage from the first voltage regulator; and
a second phase-locked loop associated with the set of sideband data paths and receiving constant voltage from the second voltage regulator.

3. The interconnect of claim 1, further comprising:
a shared ground coupled to the set of mainband data paths and the set of sideband data paths, wherein the shared ground electrically isolates the set of mainband data paths from the set of sideband data paths.

4. The interconnect of claim 1, wherein the set of mainband data paths transmit production network data between chiplets of the computing device.

5. The interconnect of claim 4, wherein the production network data comprises sensor data to be processed by the chiplets of the computing device.

6. The interconnect of claim 5, wherein the set of sideband data paths transmit functional safety data between the chiplets of the computing device.

7. The interconnect of claim 6, wherein the functional safety data comprises health monitoring information corresponding to hardware components of the computing device.

8. The interconnect of claim 4, wherein the chiplets include a sensor data input chiplet and a central chiplet that are coupled by the interconnect.

9. The interconnect of claim 1, wherein an interface between the set of mainband data paths and the set of sideband data paths includes one or more de-capping components to eliminate transient noise from the set of mainband data paths and the set of sideband data paths.

10. The interconnect of claim 1, wherein a ratio between the set of mainband data paths and the set of sideband data paths comprises a four-to-one ratio, a three-to-one ratio, a two-to-one ratio, or a one-to-one ratio.

11. A system-on-chip comprising:
a sensor data input chiplet to receive sensor data from a sensor system comprising (i) a set of cameras, and (ii) a set of LIDAR and radar sensors;
a central chiplet comprising a shared memory;
a first interconnect connecting the sensor data input chiplet and the central chiplet to transmit image data from the set of cameras; and
a second interconnect connecting the sensor data input chiplet and the central chiplet to transmit LIDAR and radar data from the set of LIDAR and radar sensors.

12. The system-on-chip of claim 11, wherein the first interconnect and the second interconnect each comprise:
a set of mainband data paths;
a set of sideband data paths;
wherein the set of mainband data paths receive constant voltage from a first voltage regulator powered by a first power source; and
wherein the set of sideband data paths receive constant voltage from a second voltage regulator powered by a second power source.

13. The system-on-chip of claim 12, wherein the first interconnect and the second interconnect each further comprise:
a first phase-locked loop associated with the set of mainband data paths and receiving constant voltage from the first voltage regulator; and
a second phase-locked loop associated with the set of sideband data paths and receiving constant voltage from the second voltage regulator.

14. The system-on-chip of claim 12, wherein the first interconnect and the second interconnect each further comprise:
a shared ground coupled to the set of mainband data paths and the set of sideband data paths, wherein the shared ground electrically isolates the set of mainband data paths from the set of sideband data paths.

15. The system-on-chip of claim 12, wherein the set of mainband data paths of the first interconnect transmit the image data from the set of cameras, and wherein the set of mainband data paths of the second interconnect transmits the LIDAR and radar data from the set of LIDAR and radar sensors.

16. The system-on-chip of claim 12, wherein the set of sideband data paths of the first interconnect and the second interconnect transmit functional safety data between the sensor data input chiplet and the central chiplet.

17. The system-on-chip of claim 11, wherein the first and second interconnects are connected by a bridge data path that enables (i) transmission of image data to the central chiplet when the first interconnect fails, and (ii) transmission of LIDAR and radar data to the central chiplet when the second interconnect fails.

18. The system-on-chip of claim 12, wherein the system-on-chip is included in a vehicle that includes the first power source and the second power source, wherein the set of cameras is powered by a third power source, and wherein the set of LIDAR and radar sensors are powered by a fourth power source.

19. The system-on-chip of claim 18, wherein the third power source and fourth power source comprise a battery of the vehicle and one of an alternator or battery pack of the vehicle.

20. A multiple-system-on-chip (mSoC) comprising:
a first system-on-chip;
a second system-on-chip; and
an interconnect communicatively coupling the first system-on-chip and the second system-on-chip;
wherein each of the first system-on-chip and the second system-on-chip comprises:
a sensor data input chiplet to receive sensor data from a sensor system comprising (i) a set of cameras, and (ii) a set of LIDAR and radar sensors;
a central chiplet comprising a shared memory;
a first interconnect connecting the sensor data input chiplet and the central chiplet to transmit image data from the set of cameras; and
a second interconnect connecting the sensor data input chiplet and the central chiplet to transmit LIDAR and radar data from the set of LIDAR and radar sensors.
